(19) United States
(12) Patent Application Publication
(10) Pub. No.: US 2024/0243813 A1
(43) Pub. Date: Jul. 18, 2024

(54) IMPROVING CLASSICAL AND QUANTUM FREE-SPACE COMMUNICATION BY ADAPTIVE OPTICS AND BY SEPARATING THE REFERENCE AND SIGNAL BEAMS WITH TIME DELAY FOR SOURCE(S) MOVING RELATIVE TO THE DETECTOR(S)

(71) Applicant: THE UNIVERSITY OF HONG KONG, Hong Kong (CN)

(72) Inventors: Hoi Fung CHAU, Hong Kong (CN); Kai Sum CHAN, Hong Kong (CN)

(73) Assignee: THE UNIVERSITY OF HONG KONG, Hong Kong (CN)

(21) Appl. No.: 18/563,361

(22) PCT Filed: May 25, 2022
(86) PCT No.: PCT/CN2022/094917

§ 371 Date: Nov. 21, 2023

Related U.S. Application Data
(63) Continuation-in-part of application No. PCT/CN2021/096100, filed on May 26, 2021.

(30) Foreign Application Priority Data
May 26, 2021 (WO) PCT/CN2021/096100

(51) Int. Cl. H04B 10/50; H04B 10/572

(52) U.S. Cl. CPC H04B 10/50572; H04B 10/572

(57) ABSTRACT

A method of improving an information transmission rate involves reducing atmospheric distortions by emitting at the same or nearly the same wavelength a reference source for adaptive optic correction and a signal source for optical communication. The reference source is brighter than the signal source and the (pulsed or continuous) reference source is emitted earlier than the (pulsed or continuous) signal source. By adjustment of the time delay between the reference source and the signal source and/or the delay time in adaptive optics control and/or apparent angular speed of the sources relative to the detecting module and/or the physical separation between the reference source and the signal source, the optical paths of a reference source beam and a signal source beam have about same wavefront distortion. The reference source beam and the signal source beam are detected in a side by side manner by detectors physically located next to each other. Adaptive optics are used for wave distortion correction on the reference source to simultaneously correct distortion of the signal source.

### CROSS REFERENCE TO RELATED APPLICATIONS

This Application is a National Stage Application of International Patent Application No. PCT/CN2022/094917, filed May 25, 2022. The International Application was published on Dec. 1, 2022 as International Publication No. WO 2022/247854 A1. Under the applicable patent law and/or rules pursuant to the Paris Convention, this application is made to timely claim the priority to and benefit of International Patent Application No. PCT/CN2021/096100, filed on May 26, 2018. The International Application was published on Dec. 1, 2022 as International Publication No. WO2022246695 A1. For all purposes, the entire disclosure of International Patent Application No. PCT/CN2021/096100 and PCT/CN2022/094917 are incorporated by reference as part of the disclosure of this application.

### TECHNICAL FIELD OF THE INVENTION

Disclosed are systems that improve information transmission rates, information transmission systems, methods of improving an information transmission rate, and related methods.

### BACKGROUND OF THE INVENTION

The reflective index of air varies slightly due to fluctuation in physical parameters such as density, pressure and temperature. As a result, atmospheric turbulence dynamically distorts the wavefront of light rays causing the transmitted image blurring and drifting. Adaptive optics (AO) is a technique to correct this type of image distortion. The basic idea is to compensate the wavefront distortion by feedback control. The most commonly used method is to dynamically adjust the deformable optical elements of the imaging system. AO techniques are widely used in fields like astronomy, optical communication, and microscopy.

In order to correct the distorted image as rapidly and accurately as possible, a sufficiently bright reference source is required. For a typical classical optical communication application, the signal source itself is bright enough to act as the reference source as well. Many implementations have been proposed and developed. One example is to divide up the image received into many sub-apertures. By dynamically adjusting the phase shifter in each sub-aperture, one can maximize the instantaneous output signal-to-noise ratio of the overall received signal.

Not all classical optical communications involving AO use a signal light source. One example is the use of reflected sunlight from a mirror mounted on a satellite as the reference source. The AO technique is then used to correct the wavefront distortion of this reference source plus an optical signal source emitted by a satellite nearby. However, there are three problems with this approach. First, sunlight is not always available. Second, the two satellites are at different altitudes and hence they are too far apart for any meaningful application of the AO correction technique most of the time. Moreover, the very bright reflected sunlight causes serious tube current in the air inside the telescope used to detect and correct the reference sunlight. This degrades the performance of the AO correction.

For astronomical applications, in order to observe a dim astronomical object of interest, astronomers use either a bright star or an artificial guide star nearby (in terms of apparent angular separation observed from the telescope) to act as the reference source. In either case, both the reference source and the astronomical object of interest pass through the same astronomical telescope optics. The idea is that as the two sources are angularly close, they should experience more or less the same wavefront distortion. Therefore, successful wavefront correction by the AO technique of the reference source should also imply the successful correction of the image of the dim astronomical object.

When the reference and signal sources move relative to the detector(s), the signal correction can be much more challenging. Moving sources imply that the effective spatial and temporal scales of atmospheric turbulence are reduced. In order to attain the same level of AO correction, the faster the relative motion, the faster the AO control has to be. This is true even if atmospheric turbulence is spatially inhomogeneous but temporally static.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

The information transmission rate can be seriously affected by atmospheric distortions in free-space communications, especially in the visible spectrum and when the source is moving relative to the detector. Described herein is the use of a reference beam plus adaptive optics to correct the effects of atmospheric distortions and at the same time transmit the classical or quantum information via nearby delayed signal beam(s). This technology is effective if the wavefront sensing module, that detects and corrects the atmospheric distortions of the reference beam, and the signal detection module that detects the actual optical communication signal, are placed near each other at the receiving end.

Disclosed herein are methods of improving an information transmission rate involving reducing atmospheric distortions by emitting at the same or nearly the same wavelength a reference source for adaptive optic correction and a signal source for optical communication. The reference source is brighter than the signal source, and the reference and signal sources move relative to the detection module. The (pulsed or continuous) reference source is emitted earlier than the (pulsed or continuous) signal source by adjusting (1) the time delay between the reference source and the signal source and/or (2) the delay time in the adaptive optics control and/or (3) the apparent angular speed of the sources relative to the detecting module and/or (4) the physical separation between the reference source and the signal source, wherein optical paths of a reference source beam and a signal source beam have about same wavefront distortion. This method involves detecting the reference source beam and detecting the signal source beam in a side by side manner; and using adaptive optics for wave distortion correction on the reference source to simultaneously correct distortion of the signal source.

Also disclosed are systems that improve information transmission rates using a wavefront sensing module that detects and corrects atmospheric distortions of a reference beam and a signal detection module that detects an actual optical communication signal that are positioned near each other in a receiving end of an information transmission system. The wavefront sensing module and the signal detection module are positioned near each other so that a center of an image of the reference beam at least overlaps with a center of an optically sensitive surface of the wavefront sensing module.

Also disclosed are information transmission systems containing a first emitter that generates a signal source for optical communication and a second emitter that generates a reference source at the same or nearly the same wavelength as the signal source. The reference source is brighter than the signal source. Further, the optical paths of a reference source beam and a signal source beam have about the same wavefront distortion. The system further includes a first detector that detects the signal source beam, a second detector that detects the reference source beam, where the first detector and the second detector are positioned in a side by side manner and adaptive optics for wave distortion correction on the reference source acts to simultaneously correct distortion of the signal source.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF SUMMARY OF THE DRAWINGS

The foregoing and other objects and advantages of the present invention will become more apparent when considered in connection with the following detailed description and appended drawings in which like designations denote like elements in the various views, and wherein:

FIG. 1 depicts a ground to ground communication arrangement in accordance with one embodiment of the present invention.

FIG. 2 depicts a satellite to ground communication arrangement in accordance with another embodiment of the present invention.

FIG. 3 depicts a flying object to ground communication arrangement in accordance with yet another embodiment of the present invention.

FIG. 4 depicts a communication arrangement for use with a telescope in accordance with still yet another embodiment of the present invention.

FIG. 5 depicts a spatial communication arrangement of an embodiment of the operational aspects of the AO techniques.

FIG. 6 depicts a temporal communication arrangement of an embodiment of the operational aspects of the AO techniques, wherein the sources move around the detector from time t=0 to t=Tr.

FIG. 7 depicts a simulation setup for the receiving end.

FIG. 8 depicts a schematic representation of the communication channel.

FIG. 9 depicts a schematic representation in which both beams are aimed at the receiver and the distance between the beams varies with z.

FIG. 10 depicts a series of graphs showing coherent efficiency γ versus separation distance L at different zenith angle & with and without AO.

FIG. 11 depicts a series of graphs showing coherent efficiency γ versus zenith angle ζ for various separation distances between the reference and signal beams L in meters.

FIG. 12 depicts a series of graphs showing coherent efficiency γ versus zenith angle ζ for spatial separation systems and WDM systems.

FIG. 13 depicts a series of graphs showing Greenwood frequency versus zenith angle.

### DETAILED DESCRIPTION OF THE INVENTION

Recently, AO techniques have been applied to ground-based free-space secure quantum communications over a distance of 19.2 km in which two photon sources of different but close wavelength—one for AO correction and the other for secret key generation—are used in a frequency multiplexing system. There are three problems in this implementation. First, it is not scalable to longer communication distances due to frequency dispersion. Second, the separation of the two frequency signals is not an effective way to achieve very low signal transmission rates. Third, it is not effective when the source moves relative to the detector. In fact, the effectiveness decreases as the relative speed increases.

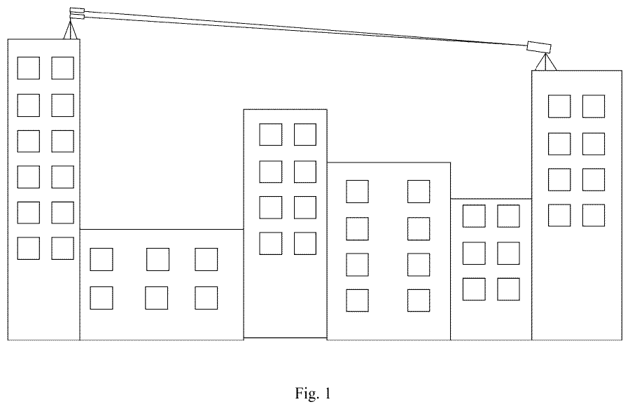

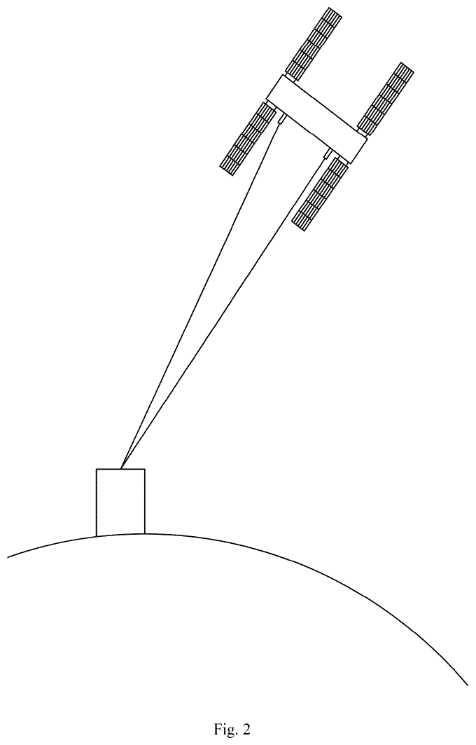

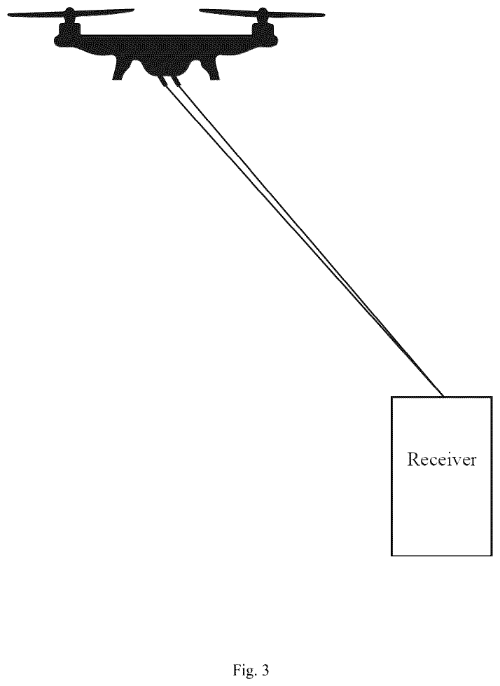

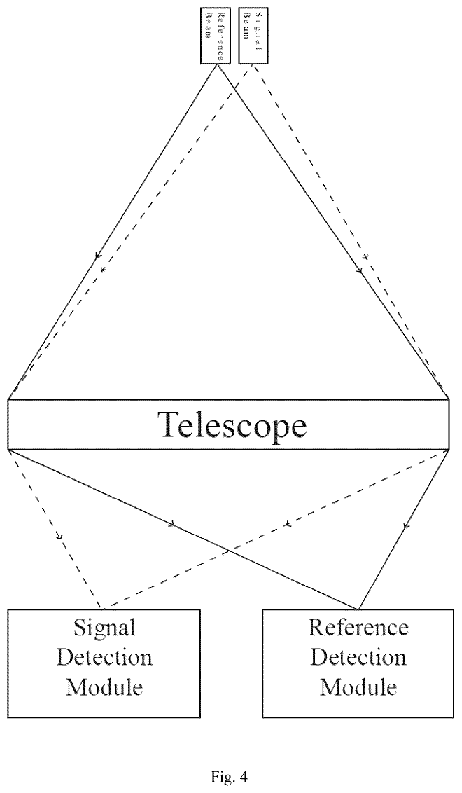

Herein, these free-space secure quantum communication problems are solved by using two set artificial sources emitting at the same or nearly the same wavelength—a bright reference source to perform effective AO correction and a weak signal source(s) for the actual optical quantum communication. Referring to FIGS. 1 to 4, these two sources are placed near each other physically. Similarly, the wavefront sensing module that detect the reference source beam and the signal detection module that detects the signal source beam(s) are placed side by side. The timing of the (pulsed or continuous) reference beam and the (pulsed or continuous) signal beam plus the AO control response time are carefully and possibly dynamically and adaptively adjusted. In this way, the optical paths of the two set of sources with the same or almost the same wavelength experience more or less the same wavefront distortion. Thus, wave distortion correction by AO on the reference source simultaneously corrects the distortion of the possibly much weaker signal source(s). Surely, the two set of sources are placed sufficiently apart so that diffraction and scattering of the reference source has negligible effect on the signal source(s) and vice versa. An advantageous feature of this method, consequently, is that the signal transmission rate is then independent of the reference source.

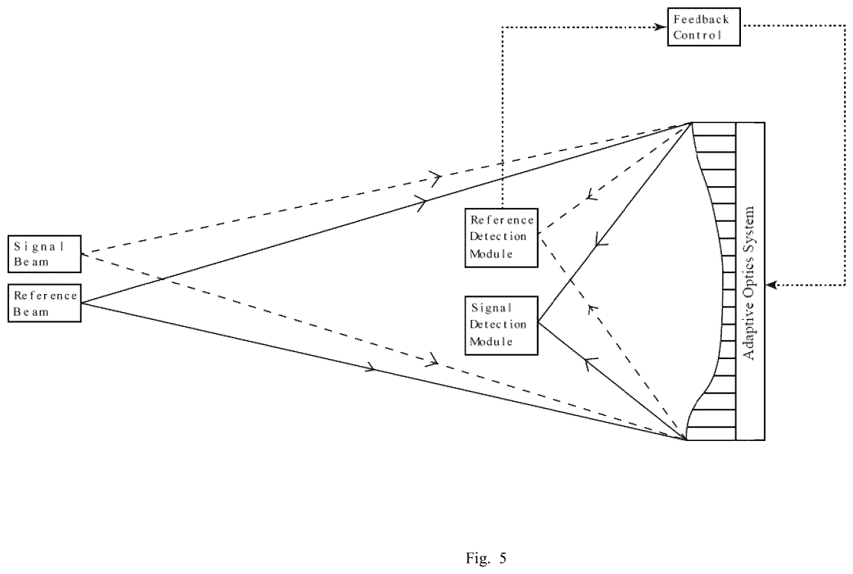

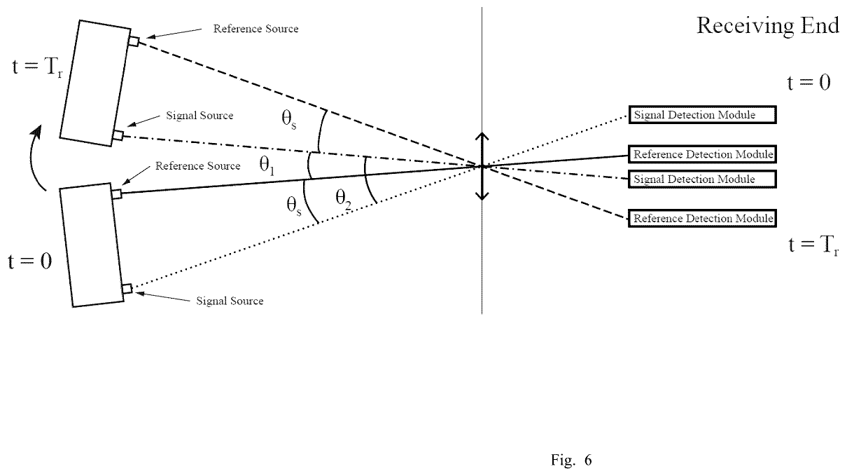

Referring to FIGS. 5 and 6, an exemplary embodiment of the present invention depicts the optical relationships amongst two set artificial sources emitting a signal beam and reference beam, an adaptive optics system, a reference detection module, a signal detection module, and feedback control to vary the adaptive optics system based upon readings of the reference detection module. That is, using information of the relative angular speed between the two beams and the two detector modules (θ₂/Tᵣ) together with the angle subtended by the reference and signal beams as observed from the detector modules (θₛ), the difference between the optical path traveled by the reference beam emitted at time t=0 and the optical path traveled by the signal beam emitted at time Tᵣ characterized by the angle θ₁ can be minimized. Provided that this time difference Tᵣ is about an order of magnitude shorter than the fluctuation timescale of the atmospheric turbulence and longer than the response time of the AO system, wave distortion correction implemented by a controller onto the adaptive optics system can minimize atmospheric distortions and thereby increase communication rates in free-space communications of the signal beam. Surely, the value of Tᵣ may be adjusted dynamically and adaptively. Furthermore, the difference between the optical paths traveled by the advanced reference beam and the delayed signal beam may be minimized by changing the angular speed of these two source beams relative to the detector modules and/or the physical separation between the two source beams, although these methods are technologically more challenging and may not be economical using current technologies.

For purposes herein, “nearly the same wavelength” means that the two wavelengths are within 50 nm of each other. Stating that “the reference and signal beams move relative to the detection modules” means that the relative angular speed between the two beams and the two detection modules is greater than the mean solar angular speed, namely, about 360° per day. The “wavefront sensing module” means equipment or a technique that measures and/or reconstructs the wavefront either directly or indirectly. In other embodiments, “nearly the same wavelength” means that two wavelengths are within 25 nm of each other. In yet other embodiments, “nearly the same wavelength” means that two wavelengths are within 10 nm of each other.

In this regard, the methods described herein are similar to the standard artificial guide star technique used in astronomy. However, there are at least three major differences. First, all sources used herein are artificial. Second, the reference source herein is placed physically close (and not just close in terms of apparent angular separation) to the signal source(s). Third, there is no need to use an advanced reference source or to adjust the response time of the AO system.

Note that the methods work not just for secure quantum communications. The methods described herein are directly applicable to classical optical communication in free-space provided the source(s) move relative to the detector(s), too. In this case, the intensity of the signal source(s) need not be low. Furthermore, the methods are applicable to ground-based, air-to-ground, as well as satellite-to-ground communications.

That is, described herein are implementations for:
1. ground-to-ground communication between two moving locations; and
2. low earth orbit (LEO) satellite-to-ground communication with the satellite moving in circular orbit at an altitude of 550 km above the ground.

Although not explicitly discussed, one can easily verify that the techniques described herein are also applicable to drone-to-ground and airplane-to-ground optical communication. To further illustrate these implementations, discussed are the following two special cases of telescope setups where the sensing modules are placed on their focal planes. The first one is based on a commercially available telescope and the second is based on an actual satellite-to-ground experiment. A 356 mm diameter telescope with blockage diameter of 114 mm and effective focal length of 3910 mm; and a 1 m diameter reflector telescope with focal length of 10 m.

### Design of the Reference and Signal Beams

The assumption with an exemplary embodiment is that two physically nearby light beams of similar frequency pass through more or less the same air column and hence their wavefronts arriving at the detector end at about the same time should be distorted in roughly the same way. As a result, a single wavefront correction method should be able to correct both light beams at the same time with high fidelity. One may question why the invention would not work if the two beams are put together and a time multiplexing technique is used, provided that the time interval of beam switching is much higher than the change in atmospheric wavefront distortion. The answer is that although pure wavelength division multiplexing works as demonstrated by recent experiments, the technique can attain a better secret key rate for moving sources. By placing the reference beam ahead of the signal beam along the direction of motion of the sources relative to the receiver, the method can better correct wavefront distortion. More importantly, by carefully tuning the apparent angular distance between the two beams and the delay time used in the AO feedback loop, it is possible to make the two beams travel through almost the same optical path. As a result, if the atmospheric turbulence fluctuation time scale is sufficiently short, the level of AO correction should be equal to the situation for non-moving sources, although this situation is not as effective as the case of moving sources.

Returning to FIG. 5, the two sources are placed physically near each other. Similarly, the wavefront sensing module that detects the reference source beam and the signal detection module that detects the signal source beam(s) should be placed side by side. To reduce photon loss in long distance communication, each of the beam source is placed at the focus of a telescope on a satellite so that the emitted light beam close to the source can be well approximated by a traveling plane wave. In this way, the optical paths of the two set of sources with the same or almost the same wavelength should experience more or less the same wavefront distortion. The reference detection module estimates the atmospheric distortion and generates feedback signals to the control system. Then, the control system drives the actuators of a deformable mirror or the spatial light modulator in the AO system. Thus, wave distortion correction by AO on the reference source should simultaneously correct the distortion of the possibly much weaker signal source(s). Surely, the two set of sources must be placed sufficiently apart so that diffraction and scattering of the reference source have negligible effect on the signal source(s) and vice versa. A nice feature of this method is that the signal transmission rate will then be independent of the reference source.

The method of the present invention is similar to the standard artificial guide star technique used in observational astronomy. The method of the invention works not just for quantum communications, but is directly applicable to classical optical communication in free-space as well. In this case, the intensity of the signal source(s) need not be low. Furthermore, the method is applicable to ground-based, air-to-ground as well as satellite-to-ground communications, and is further applicable to stationary as well as moving sources relative to the sensing and detecting modules. Note, however, that there are two major differences from the standard artificial guide star method. First, all sources the invention used are artificial. Second, the reference source is placed physically closed (and not just close in terms of apparent angular separation) to the signal source(s).

### Phase Screen Simulation

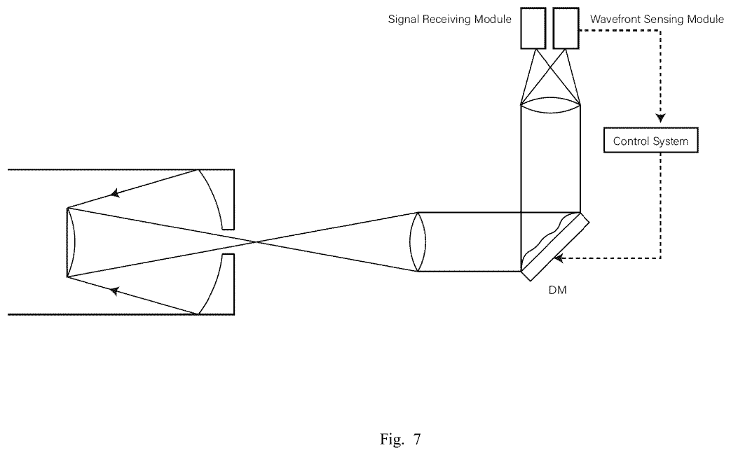

To verify the effectiveness of this method, the invention was simulated with the spatial profiles of the reference beam and the signal beam. To simplify the matter, the invention ignores the effects due to haze and cloud. Furthermore, as the angular speed of a low earth orbit (LEO) satellite is fast, the invention ignores the time-dependence of the reflective index fluctuation. In other words, the results are obtained via AO corrections on a random sample of spatially inhomogeneous reflective indices in the atmosphere. The time dependence effect of atmospheric turbulence is discussed below The invention uses the PROPER library written in Matlab to simulate the light propagation in this medium. The invention models the atmospheric phase turbulence by a set of phase screens, which are used to change the phase of the light wave. These phase screens are generated by using FFT on random complex numbers whose distribution follows the Kolmogorov's turbulence theory. Here the invention presents the detail of the equations and parameters in the phase screens generation. The invention uses the modified von Karman phase noise power spectral density (PSD), spectrum algorithm and Fresnel approximation Fourier algorithm for near-field and far-field light propagation. It also provides routines for telescope and deformable mirror simulation. The diffraction effect of the telescope is included in the simulation for a more accurate result. FIG. 7 shows the setup of the receiving end telescope and the AO system used in the simulation.

For the free-space channel, the invention divides the atmosphere into two layers. The upper layer has 1 phase screen and the lower layer has 10 phase screens. The satellite altitude, layers division altitude, and receiver altitude are 400 km, 20 km and 0 km, respectively. The size of the phase screens is 1024×1024 and the invention repeats the simulation 1000 times for each scenario. The parameters used in the simulation are shown in Table I. The specification of the telescope is based on a real telescope in the Lulin Observatory. For simplicity, the invention ignores the diffraction effect of the supporting spider vanes in the simulation. The invention uses 780 nm wavelength photon source because this wavelength has better spatial filtering strategies, geometric coupling, and size of focus spot.

Here the invention considers the situation where the quantum signal beam detection is triggered by the reference beam. The reference source sends relatively strong coherent pulses which are slightly ahead of time relative to the quantum signal pulses. This setting automatically compensates for the zero-order distortion from the turbulence. More importantly, the phase information of the reference beam is extracted as the feedback signal. The phase is compared with an ideal light beam, which propagates a perfect vacuum channel. The difference in the profiles is used to correct the phase error of the signal beam, which is spatially separated with the reference beam, by applying a deformable mirror (DM).

TABLE I
AO system parameters used in the simulations based
on a real Cassegrain telescope at the Lulin Observatory.
AO system parameters

| Signal wavelength | 780 | nm |
|---|---|---|
| DM actuator array size | 64 × 64 | |
| Initial beam diameter | 0.05 | m |
| Primary mirror diameter | 1.03 | m |
| Secondary mirror diameter | 0.36 | m |
| Focal length | 8 | m |

The invention models the atmospheric phase turbulence by a set of phase screens, which are used to change the phase of the light wave. These phase screens are generated by using FFT on random complex numbers whose distribution follows the Kolmogorov's turbulence theory. Here the invention presents the details of the equations and parameters in the generation of the phase screens. The invention uses the modified von Karman phase noise power spectral density (PSD),

$${Φ}_{ϕ}^{m v K} = \frac{0.49 {r}_{0}^{- 5 / 3} exp ( - {κ}^{2} / {κ}_{m}^{2} )}{{( {κ}^{2} + {κ}_{0}^{2} )}^{11 / 6}} \qquad ( 1 )$$

where κ₀=2π/L₀, κₘ=5.92/l₀, κ is the spatial frequency in rad/m, and r₀ in meters is the atmospheric coherence diameter, also known as the Fried parameter. Here L₀ in meters is the mean size of the largest eddies, which is also called the outer scale of turbulence; and l₀ in meters is the mean size of the smallest eddies, which is also known as the inner scale of turbulence. The invention assumes that L₀ follows the Coulman-Vernin profile,

$${L}_{0} ( h ) = \frac{4}{1 + {( \frac{h - 8500}{2500} )}^{2}} \qquad ( 2 )$$

where h is the altitude in meters. The value of r₀ varies with the altitude and the zenith angle according to the equation

$${r}_{0} = {[ 0.423 {k}^{2} sec ( ζ ) {\int }_{0}^{+ h} {C}_{n}^{2} ( h ) d h ]}^{- 3 / 5} \qquad ( 3 )$$

where ζ is zenith angle, k is the wavenumber of the light, and Cₙ²(h) is the refractive index structure parameter. The invention uses the Hufnagel-Valley model for Cₙ²(h) in the simulation, namely,

$${C}_{n}^{2} ( h ) = 0.00594 {( \frac{v}{27} )}^{2} {( \frac{h}{1 {0}^{5}} )}^{10} exp ( - \frac{h}{1000} ) + 2.7 \times 1 {0}^{- 16} exp ( \frac{- h}{1500} ) + 1 \text{.7} \times {10}^{- 14} exp ( \frac{- h}{100} ) \qquad ( 4 )$$

Here v=21 m/s is the wind speed.

The Fourier transform method with subharmonics stated in the book “Numerical Simulation Of Optical Wave Propagation: With Examples In Matlab” by J. Schmidt (2010) is used to generate phase screens. The phase screen of Fourier transform method can be written as

$$ϕ ( x , y ) = {\sum }_{n = - ∞}^{∞} {\sum }_{m = - ∞}^{∞} {c}_{n , m} exp [ i 2 π ( {f}_{{x}_{n}} x + {f}_{{y}_{m}} y ) ] \qquad ( 5 )$$

where fₓ and f_{y} are the spatial frequencies along the x and y directions, respectively. Furthermore, c_{n,m} are random complex coefficients that have circular complex Gaussian distribution with variance given by

$$〈 {\vert {c}_{n , m} \vert}^{2} 〉 = {Φ}_{ϕ}^{mvK} ( {f}_{{x}_{n}} , {f}_{{y}_{n}} ) Δ {f}_{{x}_{n}} Δ {f}_{{y}_{n}} = \frac{1}{{L}_{x} {L}_{y}} {Φ}_{ϕ} ( {f}_{{x}_{n}} , {f}_{{y}_{n}} ) \qquad ( 6 )$$

The invention uses the subharmonic method that proposed by Lane et al. to create a low frequency phase screen. More precisely, a low frequency phase screen is generated using subharmonic and is added to the FT phase screen. The screen ϕ_{LF} (x, y) is computed by summing the N_{P} phase screens, namely,

$${ϕ}_{L F} ( x , y ) = {\sum }_{p = 1}^{{N}_{P}} {\sum }_{n = - 1}^{1} {\sum }_{m = - 1}^{1} {c}_{n , m} exp [ i 2 𝔫 ( {f}_{{x}_{n} , p} x + {f}_{{y}_{m} , p} y ) ] \qquad ( 7 )$$

The frequency spacing of the p^{th} screen the invention uses is Δfₚ=1/(3^{p}L).

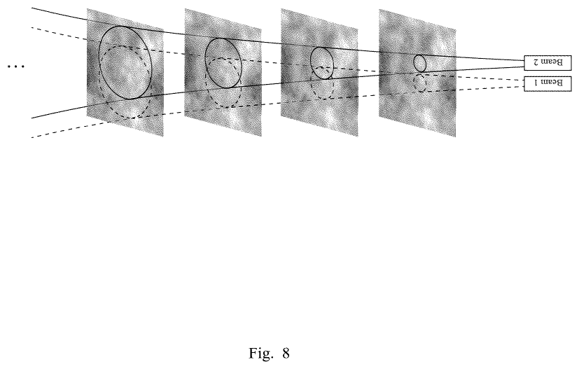

FIG. 8 is schematic representation of the communication channel. The grey scale plates here are the randomly generated (time independent but spatially inhomogeneous) phase screens. The grey scale of each pixel represents the phase change when light passes through that region.

To simulate the spatial correlation of the reference beam and the signal beam, the invention passes both (spatially separated) beams through the same set of phase screens. As shown in FIG. 8, the area overlapped by the two beams on the phase screen increases as they propagate. This means that the reference beam contains more turbulence information of the signal beam as the transmission distance increases. As there is nearly no turbulence when h is high, the wavefront distortion due to the first phase screen is almost zero. Consequently, the performance of the system is unaffected even though the two beams do not overlap on the first phase screen.

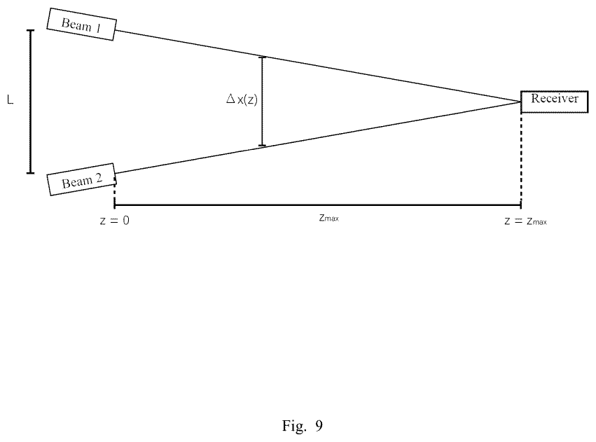

Note that the overlapping area of the two beams increases if either the individual beam size or the transmission distance of the beams increase. As shown in FIG. 9, the beams are tilted at a small angle to aim at the receiver. The invention assumes that the centers of the beams reach the receiving end at the same location. Therefore, when they pass through a phase screen, one beam is offset to a certain distance, Δx=L(zₘₐₓ−Z)/zₘₐₓ. Here L, zₘₐₓ and z are the separation between the beams, distance between the transmitter and the receiver and the propagated distance. Since L<<zₘₐₓ, the beams travel the same distance and the relative tilt angle can be ignored.

The signal aberration caused by the turbulence is quantified by the coherent efficiency,

$$γ = \frac{\vert \frac{1}{2} \int \int [ {E}_{ideal}^{*} {E}_{received} + {E}_{ideal} {E}_{received}^{*} ] ds \vert}{\int \int {\vert {E}_{ideal} \vert}^{2} ds \int \int {\vert {E}_{received} \vert}^{2} ds} \qquad ( 8 )$$

In the above expression, E_{ideal} is the electric field in the ideal situation, which is when the beam passes through a vacuum channel, and E_{received} is the distorted or compensated electric field. Moreover, the integral is over the receiver surface. Clearly, 0≤γ≤1; and γ=1 means that E_{ideal} and E_{received} align perfectly.

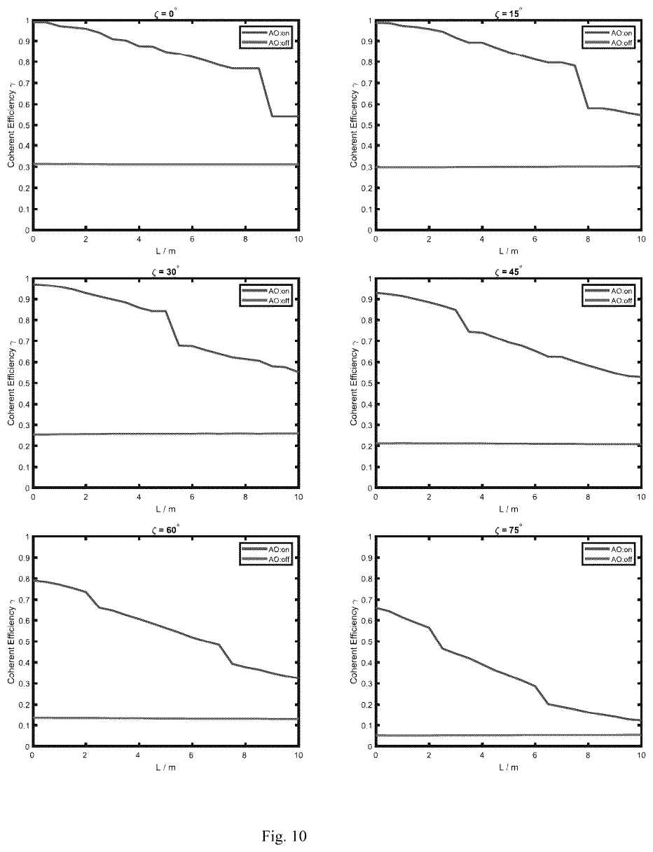

FIG. 10 shows the simulation result of the coherent efficiency γ versus separation distance graphs, L. Without AO correction, γ is about 0.3 with zenith angle ζ=0° and it is around 0.05 with ζ=75°. As expected, γ increases after using AO. For instance, when L=2 m, the system can correct the distortion to γ=0.958 at ζ=0° and γ=0.566 at ζ=75°. Note that γ decreases when L increases as the overlapping area of the beams is reduced. The phase distortion of the reference beam is less relevant to the signal beam. For each ζ, the coherent efficiency suddenly drops as L increases. Besides, the distance L for this sudden drop to occur decreases with ζ. This drop is related to the isoplanatic angle of the turbulence. When the angle between the two sources is smaller than the isoplanatic angle, their distortion can be considered as almost the same. Hence, when L increases so that the angular separation between the two sources increases beyond the isoplanatic angle, the effectiveness of AO correction decreases suddenly. Last but not least, for a fixed L, the value of γ decreases as the zenith angle ζ increases for two reasons—the light beams have to travel along longer optical paths, and the Fried parameter r₀ in Eq. (3) gets smaller.

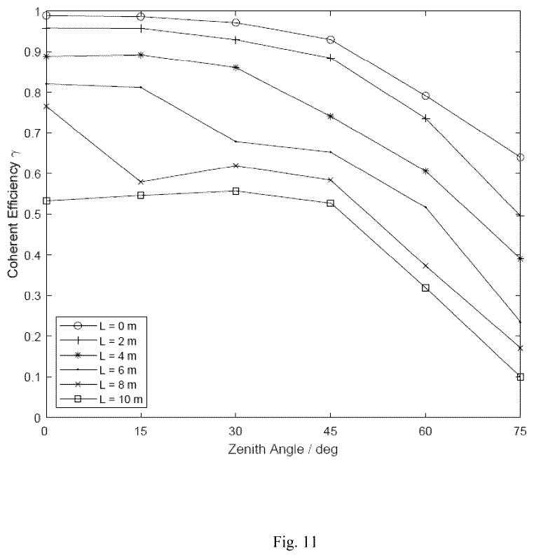

Note that the system cannot perfectly recover the signal even at L=0 because of the limited number of actuators in the DM. Thus, it is not able to completely compensate high order turbulence. Contribution of high order distortion becomes more significant when ζ increases. Thus, γ is not one and it decreases as shown in FIG. 11.

### Spatial Dependence of Turbulence

### Comparison Between Wavelength Division Multiplexing and the Scheme

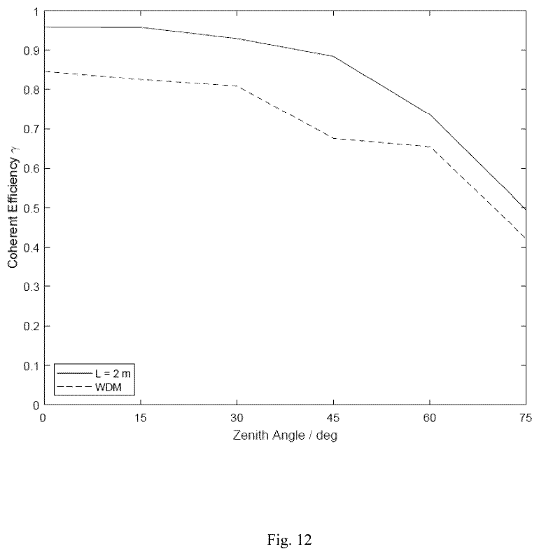

The invention compares the coherent efficiency of the method with systems that use wavelength division multiplexing (WDM) to combine the signal beam and the reference. The phase deviation is inversely proportional to the wavelength. In the simulation, the invention adjusts the phase screens according to the ratio of the wavelength of the signal beam and the reference beam. The invention sets the reference wavelength to the standard optical communication wavelength of 808 nm. The results of WDM systems are compared to the systems that separate the signal and reference beams by 2 m. The comparison is shown in FIG. 12, where the coherent efficiency of the spatial separation scheme is at least 10% higher than AO systems using WDM to combine. When ζ≤30°, the coherent efficiency with L=2 m is about 0.96, which is about 13% higher than the WDM scheme. Note that the chromatic distortion of the equipment is not included in the simulations. The actual performance of the WDM method will be lower. FIG. 12 shows that coherent efficiency γ versus zenith angle ζ for spatial separation systems and WDM systems. The upper line is calculated with L=2 m. The lower line is calculated with the wavelength of the reference is 808 nm.

### Maximum Path Difference Between the Advanced Reference Beam and the Delayed Signal Beam

Clearly, the AO technique works if the optical paths of the two light sources experience more or less the same optical distortion at all times. This requirement is satisfied provided that, for the sections of their paths in the atmosphere, their angular separation is less than the isoplanatic angle θ₀. The typical value of the isoplanatic angle can be estimated using the Hufnagel-Valley model. For Special Case 2 in which a satellite is about 550 km above the ground, the AO system can perform well when the physical separation of the two sets of light sources is at about 3.5 m apart. Note that satellite-to-ground optical communication is most effective when the satellite is close to the zenith. Moreover, the distance between a satellite and the ground station varies slowly as the satellite moves slightly around the zenith position. The value of θ₀ decreases when the zenith angle increases. However, even if the angular separation of the sources is larger than θ₀, the AO system can still provide some degree of improvement to the signal. As long as the angular separation between the light sources is in the same order as θ₀, the overlapping region of paths of the beams is still large enough for the system to extract the turbulence information of the signal beam.

### Maximum Physical Distance Between the Reference and Signal Sources

Clearly, the AO technique is effective if the optical paths of the two light sources experience more or less the same optical distortion at all times. This requirement is satisfied when the separated distance of the light sources is less than zₘₐₓθ₀, where

$${θ}_{0} = {[ 2.913 {k}^{2} {sec}^{8 / 3} ( ζ ) {\int }_{0}^{{h}_{ma x}} {h}^{5 / 3} {C}_{N}^{2} ( h ) dh ]}^{- 3 / 5} \qquad ( 9 )$$

is the isoplanatic angle, and hₘₐₓ is the attitude of the source. This fact is verified in the simulation results, which show a significant drop in coherent efficiency when the separation of the beams is too large compared to the isoplanatic angle.

### Maximum Delay Time Between the Advanced Reference Beam and the Delayed Signal Beam and the Maximum Response Time of the AO System

Standard AO correction techniques can be used to correct image drift (by dynamically adjusting the tilt of optical elements) and blur (by dynamically adjusting the shape of the optical elements). Effective AO correction herein means that the AO system has to operate at a response time at least about an order of magnitude shorter than the dynamical timescale of the optical distortion of either light path. Moreover, this response time must be less than or equal to the delay time between the advanced reference beam and the delayed signal beam. For Special Cases 1 and 2, the method herein works if the response time of the entire AO system, including electronics, control and mechanical parts as well as the delay time between the reference beam and signal beam, are ≤≈t₀ where t₀ is the dynamic timescale of the wavefront distortion. Note that typically, to is at least 10 ms.

Surely, the two sources and the sensing modules must be properly synchronized. In addition, the two sources must be precisely aligned relative to each other. Fortunately, the invention only needs to do it once. The invention also needs to dynamically align the sources with the detector optics with very accurate tracking.

### Minimum Size of the Optically Sensitive Surface of the Wavefront Sensing Module

The size of the optically sensitive surface of the wavefront sensing module must be large enough for effective AO correction. Let us consider a point source of light with frequency v, wavelength λ, and maximum electric field strength E_{R}. (To be more precise, E_{R} should be regarded as the maximum electric field strength of the photon beam shortly before it enters the detection optics. Basically, this is the actual E_{R} of the source after discounting the atmospheric absorption and scattering.) Suppose that this source is R away from a circular aperture of diameter D (in other words, the case of a refracting telescope), then the electric field strength at an angle θ to the circular aperture due to diffraction in the far field case equals

$$E = \frac{2 {ε}_{R} {e}^{2 π t ( vt - R / λ )}}{R} [ {π ( \frac{D}{2} )}^{2} ] ( \frac{λ}{π D sin θ} ) {J}_{1} ( \frac{π D sin θ}{λ} ) \qquad ( 10 )$$

where J₁ is the Bessel function of the first kind. More generally, for a circular aperture with a central circular blockage of diameter bD (that is to say, the case of a catadioptric telescope in Cassegrain focus), E is given by

$$E = \frac{2 {ε}_{R} {e}^{2 π t ( vt - R / λ )}}{R} [ {π ( \frac{D}{2} )}^{2} ] ( \frac{λ}{π D sin θ} ) [ {J}_{1} ( \frac{π D sin θ}{λ} ) - {bJ}_{1} ( \frac{b π D sin θ}{λ} ) ] . \qquad ( 11 )$$

The case of a Newtonian reflector can be computed in a similar way although it is more complicated due to the effect of the presence of mechanical support that blocks part of the optical path.

After AO correction, the electric field strength of the image received by the optically sensitive surface of the wavefront sensing module should obey either Eq. (10) or (11) depending on the optical design of the detecting telescope. The image correction method works best if at least two diffraction rings are recorded by this sensing module. For a telescope of effective focal length f, this means that the size of the optically sensitive surface of the wavefront sensing module l_{w} has to satisfy the inequality

$$\frac{π D {ℓ}_{W}}{λ f} \approx \frac{π D sin θ}{λ} ≳ 10 \qquad ( 12 )$$

for all b≤1. If the wavelength of the light source is λ=405 nm, which equals a known Satellite-to-Earth communication experiment, then l_{w}≥≈14 nm for either Telescope Setup (i.) or (ii.). This value of l_{w} is easily attainable in current technology.

### Minimum Physical Distance Between the Reference and Source Sources

The minimum possible distance of the reference and source is determined by both the resolving power of the optics and the “interference” between the two set of sources. Note that upon successful AO correction, the center of the image of the reference beam should be around the center of the optically sensitive surface of the wavefront sensing module. Suppose the linear size of the optically sensitive surface of the signal detection module is lₛ. Suppose further that the separation between the optically sensitive surfaces of the wavefront sensing and signal detection modules is dₛₑₚ. From Eqs. (10) and (11), the light intensity of the reference beam at a distance x away from the center equals

$${l}_{R} ( x ) \approx {l}_{R} ( 0 ) {{( \frac{f λ}{π Dx} )}^{2} [ {J}_{1} ( \frac{π Dx}{f λ} ) - b {J}_{1} ( \frac{b π Dx}{f λ} ) ]}^{2} \qquad ( 13 )$$

where f is the effective local length of the telescope, b=0.36/1.03 is ratio of the diameters of the secondary to primary mirrors of the Cassegrain telescope used, and I_{R}(0)≈2ε₀E_{R}²π²(D/2)⁴/R². Hence, the total light energy flux of the reference beam imparted on the optically sensitive surface of the signal detection module is ∫∫s I_{R}(x) dA, where the integral is over the area of the field stop of the signal detection module. For example, when L=2 m, ∫∫s I_{R}(x) dA=4.36×10⁻¹⁵I(0). The minimum distance should be set according to the required decay from the beam center. Otherwise, stray reference beam photons will seriously affect the signal detection statistics. The integral is over the optically sensitive surface of the signal detection module S. This energy flux must be at least, say, 10⁻⁴ to 10⁻³ times weaker than the energy flux of the signal beam imparted on the optically sensitive surface of the signal detection module. Otherwise, stray reference beam photons will seriously affect the signal detection statistics. This can be achieved easily by tuning D, f, lₛ and dₛₑₚ because |J₁ (x)|˜x^{-1/2} for large x.

### Time Dependence of Turbulence

In the above discussion, the invention only considered the spatial correlation of the beams. In reality, the system takes a short period of time to response. For a stationary ground-based observer, the apparent angular speed of LEO satellites is much faster than that of celestial objects, this puts a more stringent requirement for AO systems in satellite communication.

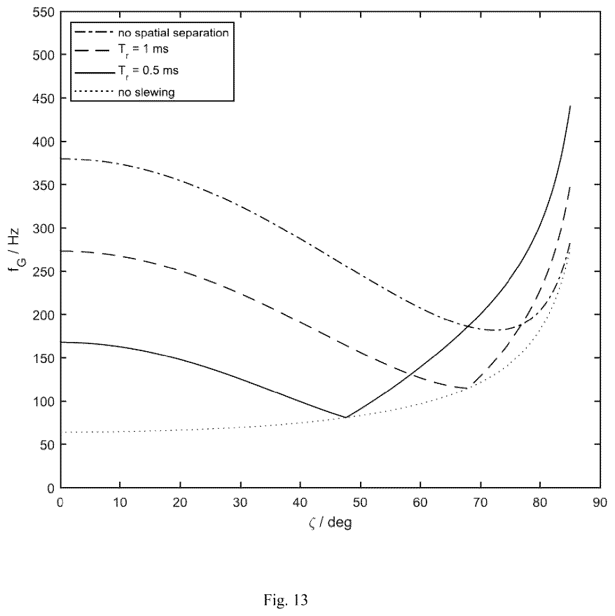

To compare the difference between a stationary and a moving source, the invention uses the Greenwood frequency f_{G}, which is an effective way to approximately quantify the rate of change of turbulence [7, 22]. Recall that

$${f}_{G} = {[ 0.1022 {k}^{2} sec ( ζ ) {\int }_{0}^{{h}_{ma x}} {C}_{n}^{2} ( h ) {v}^{5 / 3} ( h ) dh ]}^{3 / 5} \qquad ( 14 )$$

where v(h)=v_{wind}(h)+vₐₚₚ(h) is the natural wind speed plus the apparent wind speed due to the movement of the satellite. This assumption of simply adding two velocities as scalars is justified because the LEO satellite moves at great angular speed so that vₐₚₚ>>v_{wind}. The invention further assumes that the natural wind speed follows the altitude-dependent Bufton wind profile,

$${v}_{wind} ( h ) = {v}_{g} + 30 exp [ - {( \frac{h - 9400}{4800} )}^{2} ] \qquad ( 15 )$$

where v_{g}=5 m/s is assumed to be the natural wind speed near the ground. Adding the apparent wind speed, vₐₚₚ(h)=ωₛh, the total wind speed can be written as,

$$v ( h ) = {ω}_{s} h + {v}_{g} + 30 exp [ - {( \frac{h - 9400}{4800} )}^{2} ] \qquad ( 16 )$$

where ωₛ is the angular slewing rate of the satellite. For simplicity, the invention assumes that the satellite is moving in a circular orbit. The angular slewing rate, therefore, equals

$${ω}_{s} = {[ \frac{{GM}_{⊕}}{{h}_{ma x}^{2} ( {h}_{ma x} + {R}_{⊕} )} ]}^{1 / 2} {cos}^{2} ( ζ ) , \qquad ( 17 )$$

where G is the universal gravitational constant, M_{⊕} and R_{⊕} are the Earth mass and radius, respectively. Since vₐₚₚ>>v_{wind}, the Greenwood frequency for the LEO satellite tracking case can be much higher than the intrinsic frequency of the atmospheric turbulence. As shown in FIG. 13, when the zenith angle is 0°, f_{G} intrinsic to the channel is about 64 Hz while f_{G}≈380 Hz when slewing is included. FIG. 13 is a graph of Greenwood frequency versus zenith angle. The dash-dotted curve is computed with slewing and no spatial separation. The dotted curve is the Greenwood frequency intrinsic to the channel. The solid and the dashed curves are computed with 2.5 m spatial separation and with response times of 1 ms and 0.5 ms, respectively.

The idea the invention proposed can reduce the apparent wind speed if the reference is placed ahead of the signal beam. Let the system response time be Tᵣ. When the system receives the reference signal at t=0, it compensates the signal at t=Tᵣ. FIG. 6. shows the satellite location and beams' path at t=0 and t=Tᵣ. Here θ₁ is the angle between the advanced reference beam and the delayed signal beam (solid and dash-dotted lines) whereas θ₂ is the angle between the signal beam paths at t=0 and t=Tᵣ (dotted and dash-dotted lines). FIG. 6 further shows that if both beams are placed at the same location, the angle between the two timestamps is larger then the case in which the beams are spatially separated. The apparent wind speed can therefore be reduced by a factor of θ₁/θ₂. The equivalent angular slewing rate is

$${ω}_{s}^{′} = {ω}_{s} \frac{{θ}_{1}}{{θ}_{2}} = {ω}_{s} \frac{\vert {θ}_{2} - {θ}_{s} \vert}{{θ}_{2}} = {ω}_{s} \frac{\vert {ω}_{s} {T}_{r} - {θ}_{s} \vert}{{ω}_{s} {T}_{r}} = \vert {ω}_{s} - \frac{{θ}_{s}}{{T}_{r}} \vert \qquad ( 18 )$$

where θₛ=L/zₘₐₓ is the angular separation between the reference and the signal beam. Combined with Eqs. (14) and (16), it is clear that one can completely eliminate the effect of apparent wind speed and hence attain optimal performance for the AO system if θₛ/Tᵣ=ωₛ. Indeed this is what the invention shows in FIG. 13.

Note that for θₛ/Tᵣ<ωₛ, the performance of the setup is worse than the case of a stationary source because the AO system response time is not fast enough to allow the pulsed signal and reference beams to travel through an almost identical optical path. The more interesting case is when θₛ/Tᵣ>ωₛ. In this case, the reduction in performance as reflected by the value of f_{G} is because the system response time Tr is too fast. Surely, by artificially increasing Tr, say, by suitably increasing the delay in the AO feedback control, the invention can reduce f_{G} to the optimal case.

Lastly, in FIG. 13, when the zenith angle is not large, the Greenwood frequency curves calculated with L=2.5 m are lower than the curve calculated with no spatial separation. Since both ωₛ and θₛ/Tᵣ decrease when the zenith angle increases, the curves decrease and approach the intrinsic frequency curve. Also, as ωₛ decreases more rapidly than θₛ/Tᵣ along ζ, the curves with spatial separation intersect the curve without slewing. This means θₛ/Tᵣ=ωₛ at that point. For zenith angle larger than this point, θₛ/Tᵣ>ωₛ, the response time should be decreased to keep the frequency near the intrinsic frequency.

### Scattering Noise by the Strong Beam

The scattering caused by the strong reference beam will affect the final key rate. Some photons from the reference may enter the signal receiving module and create errors. In this section, the invention estimates the scattering by the strong laser in the clear sky scenario. Here the invention uses the approach of sky-scattering noise to get a rough estimation of the laser scattering noise. The equation for calculating the number of sky-noise photons entering the system is given by,

$${N}_{b} = \frac{{H}_{b} ( λ ) {Ω}_{FOV} π {D}_{R}^{2} λΔλΔ t}{4 h c} \qquad ( 19 )$$

where H_{b} in W m⁻²sr μm is the sky radiance, Ω_{FOV}=πΔθ²/4 is the solid-angle field of view with a field stop, D_{R} is diameter of the receiver primary optic, Δλ equals the spectral filter bandpass in μm, and Δt is the photon integration time of the receiver. Here Δθ is calculated by D_{FS}/f with D_{FS} being the diameter of the field stop. The invention assumes Δλ=1 as both beams use the same or nearly the same wavelength, the spectral filter is not able to block the photons from the reference beam.

In astrophotography, a bright star that is close to a target can be used as a reference to probe the channel. Therefore, the brightness of the reference laser should be similar to a bright star. The sky radiance caused by the laser can be estimated by the sky radiance caused by the stars. In a moonless clear night condition, the typical sky radiance is 1.5×10⁻⁵ W m⁻²sr μm. Using the parameters mentioned above and letting Δt=1 ns, the probability of receiving a reference photon will be in the order of 10⁻⁸, which is good enough in practice.

The disclosure proposes a novel method to apply AO technologies to optical communication systems. The main idea of this method is to separate the reference and the signal beam spatially. As both beams are using the same or nearly the same frequency, the signal distortion information collected from the reference could be more accurate than systems that using WDM. The invention analyzes this by using phase screen simulations. The result shows that the performance of the scheme is better than the WDM method for the LEO satellite case. Moreover, for fast-moving sources, the design can reduce the apparent wind speed caused by the movement of the object. This can reduce the Greenwood frequency of the turbulence. The invention uses the Bufton wind profile to verify this analytically. Lastly, the invention estimates the cross-talk caused by the diffraction and the scattering of the reference. As there is a FS in the reference receiving module and the power of the reference is not high, the cross-talk by the reference can be neglected.

The disclosure herein increases the classical and quantum communication rate in free-space in the presence of wavefront distortion due to the atmosphere for source(s) moving relative to the detector(s). More specifically, the disclosure herein uses an adaptive optics technique with an artificial reference beam source placed close to a possibly much weaker signal source(s) plus putting the wavefront sensing module and the signal detecting module in the receiver side close to each other. Furthermore, the delay time between the emission of the reference beam and the emission of the signal beam as well as the response time of the AO system are adjusted, possibly dynamically and adaptively, so that the reference beam and the delayed signal beam move through more or less the same optical path.

Unless otherwise indicated in the examples and elsewhere in the specification and claims, all parts and percentages are by weight, all temperatures are in degrees Centigrade, and pressure is at or near atmospheric pressure.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.”

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A method of improving an information transmission rate, comprising the steps of:
reducing atmospheric distortions by emitting at the same or nearly the same wavelength a reference source for adaptive optic correction and a signal source for optical communication, the reference source being brighter than the signal source, the reference and signal sources move relative to a detection module, the (pulsed or continuous) reference source is emitted earlier than the (pulsed or continuous) signal source,
adjusting the time delay between the reference source and the signal source and/or the delay time in adaptive optics control and/or apparent angular speed of the sources relative to the detecting module and/or the physical separation between the reference source and the signal source, wherein optical paths of a reference source beam and a signal source beam have about same wavefront distortion;
detecting the reference source beam and detecting the signal source beam in a side by side manner; and
using adaptive optics for wave distortion correction on the reference source to simultaneously correct distortion of the signal source.

2. The method according to claim 1, wherein frequency multiplexing and/or time multiplexing and/or spatial model multiplexing techniques is/are used in the reference source beam and/or signal source beam.

3. The method according to claim 1, wherein the reference source is physically adjacent the signal source.

4. The method according to claim 1, wherein the information transmission rate is within an optical communication method.

5. The method according to claim 1, wherein the information transmission is within a classical, quantum, or a combination of classical and quantum communication method.

6. The method according to claim 1, wherein the method involves one or more ground-based, surface of a celestial object-based, flying object-based, satellite-based, space probe-based and/or underwater-based reference source beam(s) and signal source beam(s); and detecting the reference source beam(s) and signal source beam(s) on the ground, on the surface of celestial object(s), on flying object(s), on satellite(s), on space probe(s) and/or underwater.

7. The method according to claim 1, wherein the reference source beam(s) and the signal source beam(s) travel partly or completely through telescope(s), or optical fiber(s).

8. The method according to claim 1, wherein the reference source beam(s) and the signal source beam(s) travel partly or completely through water, inter-planetary space, atmosphere of celestial object(s), fluid on Earth, and/or fluid on celestial object(s).

9. The method according to claim 1, wherein the information transmission is through a classical, quantum or a combination of classical and quantum network.

10. A system that improves an information transmission rate, comprising:
one or more pair of a wavefront sensing module and a signal detection module that each directly or indirectly detects and corrects atmospheric distortions of the corresponding reference beam,
wherein each signal detection module that detects an actual optical communication signal is positioned near the corresponding reference beam in a receiving end in an information transmission system, and
wherein each pair of wavefront sensing module and signal detection module are positioned near each other so that a center of the corresponding image of the reference beam is at least overlapped with a center of the corresponding optically sensitive surface of the wavefront sensing module.

11. An information transmission system, comprising:
one or more pair of emitters wherein
the first emitter in each pair generates a signal source for optical communication;
the second emitter in each pair generates a reference source at the same or nearly the same wavelength as the signal source, the reference source being brighter than the signal source, wherein optical paths of a reference source beam and a signal source beam have about same wavefront distortion;
one or more pairs of detectors wherein
the first detector of each pair detects the signal source beam;
the second detector of each pair detects the reference source beam, the first detector and the second detector being positioned in a side by side manner;
an adjustable time delay between the (pulsed or continuous) reference source and the (pulsed or continuous) signal source and/or the delay time in adaptive optics control and/or apparent angular speed of the sources relative to the detecting module and/or the physical separation between the reference source and the signal source are made dynamically and/or adaptively; and
adaptive optics for wave distortion correction on the reference source to simultaneously correct distortion of the signal source.

12. The information transmission system according to claim 11, wherein the first emitter and the second emitter of each pair are comprised of a ground-based structure, a body on a surface of a celestial object, a flying object, a satellite, a space probe or an underwater object.

13. The information transmission system according to claim 11, wherein the signal source beam(s) and the reference source beam(s) travel through telescope(s), or optical fiber(s).

14. An information transmission system according to claim 11, wherein the adaptive optics control is replaced by another real-time signal processing and/or signal post-processing techniques.

15. An information transmission system according to claim 11, wherein the distance or angle between the optical paths of the advanced reference beam and the delayed signal beam of the moving source relative to the detector module is less than the corresponding distance or angle between the optical paths of the two beams when the source is stationary relative to the detector module.

16. An optical imaging system according to claim 11.

17. An optical imaging system according to claim 12.

18. An optical imaging system according to claim 13.

19. An optical imaging system according to claim 14.

20. An optical imaging system according to claim 15.
